(19) United States
(12) Patent Application Publication
(10) Pub. No.: US 2021/0155171 A1
(43) Pub. Date: May 27, 2021

(54) VEHICLE DASH WITH RECYCLED MATERIALS

(71) Applicant: TESLA, INC., Palo Alto, CA (US)

(72) Inventor: Franz Von Holzhausen, Malibu, CA (US)

(21) Appl. No.: 16/953,058

(22) Filed: Nov. 19, 2020

Related U.S. Application Data
(60) Provisional application No. 62/938,832, filed on Nov. 21, 2019.

(51) Int. Cl. B60R 13/02; C08L 3/02; C08L 1/02; B60R 21/2165

(52) U.S. Cl. CPC B60R 13/0256; B60R 21/2165; C08L 1/02; C08L 3/02

(57) ABSTRACT

A vehicle having an interior panel, wherein the interior panel comprises a recycled material is described. The recycled material may comprise a recycled base material and a resin.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field of the Invention

The present disclosure relates to vehicle component materials. More specifically, the present disclosure relates to environmentally-friendly materials for vehicle dashboards and other vehicle components.

### Description of the Related Art

Conventional vehicles, for example automotive vehicles, generally have interior components and paneling made from synthetic materials in order to meet numerous governmental regulations for safety and reliability. However, many of these conventional interior components are discarded once the vehicle reaches the end of its lifespan. These conventional interior components increase landfill waste and a vehicle's carbon footprint.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

In one aspect, a vehicle having an interior panel is described, wherein the interior panel comprises a recycled material, and wherein the recycled material comprises a recycled base material and a resin.

In some embodiments, the recycled material is biodegradable. In some embodiments, the recycled material is a recyclable material.

In some embodiments, the recycled base material is selected from the group consisting of a bio-based material, a petrochemical-based material, and combinations thereof. In some embodiments, the recycled base material is selected from the group consisting of paper, cardboard, fiberboard, wood, pulp, bamboo, hemp, cork, desert sand, bioplastics, mycelium, a fiber alloy, cellulose nanofibers, biodegradable polymers (BDPs), and combinations thereof. In some embodiments, the fiberboard is medium density fiberboard (MDF). In some embodiments, the cellulose nanofibers are wood nanofibers. In some embodiments, the BDPs are selected from the group consisting of natural rubbers, polyesters, aliphatic polyesters, aromatic copolyesters, poly(vinyl alcohol), and combinations thereof. In some embodiments, the BDPs are selected from the group consisting of a polyhydroxyalkanoate based BDP, a poly-3-hydroxybutyrate based BDP, a polyglycolic acid based BDP, a polybutylene succinate based BDP, a polycaprolactone (PCL) based BDP, and a polybutylene succinate terephthalate based BDP, and combinations thereof. In some embodiments, the recycled material comprises the recycled base material in an amount of at least about 50 wt. %.

In some embodiments, the resin is selected from the group consisting of: an acrylic resin, a urethane resin, a BPD-based resin, biodegradable resin, and a bio-based resin. In some embodiments, the resin is potato starch. In some embodiments, the recycled material comprises the resin in an amount from about 10 wt. % to about 20 wt. %.

In some embodiments, the recycled material is resistant to temperature damage from temperatures of about −40° C. to about 115° C. In some embodiments, the recycled material is resistant to humidity damage from atmospheric humidities of at least about 95%. In some embodiments, the recycled material has an ultraviolet (UV) damage resistance of at least about 1200 kJ/m². In some embodiments, the recycled material has a flammability resistance of at most about 100 mm/min. In some embodiments, the recycled material is a treated recycled material.

In some embodiments, the recycled material is a top most layer of the interior panel. In some embodiments, the interior panel further comprises a substrate material disposed under the recycled material. In some embodiments, the interior panel comprises a film disposed over the recycled material. In some embodiments, the interior panel does not comprise a film disposed over the recycled material. In some embodiments, the interior panel further comprises a tear seam, wherein the tear seam is configured to tear due to the force caused by a deployed airbag. In some embodiments, the interior panel is a dashboard. In some embodiments, the vehicle further comprises an electric motor.

### BRIEF DESCRIPTION OF THE DRAWINGS

FIG. 1 illustrates a top perspective view of one example of a dashboard (often called an “instrument panel”) comprising an environmentally friendly material.

FIG. 2 is a perspective view of a vehicle that may include a dashboard made from an environmentally friendly material, such as the dashboard from FIG. 1.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure may be understood by reference to the following detailed description. It is noted that, for purposes of illustrative clarity, certain elements in various drawings may not be drawn to scale, may be represented schematically or conceptually, or otherwise may not correspond exactly to certain physical configurations of embodiments.

Embodiments relate to vehicle components and interiors panels (e.g. such as a vehicle dashboard) that can be made from sustainable, recyclable, recycled, biodegradable, compostable, and otherwise environmentally friendly materials. Many environmentally-friendly materials have not conventionally been implemented in previous vehicle components because they have been too weak to provide for the rigorous demands of vehicular applications. For example, large temperature variations, high vibration, high humidity, exposure to ultraviolet (UV) light, flammability issues, and exposure to other external environmental conditions, including continuous passenger wear and tear, have caused premature failure of many vehicle components made from nontraditional materials. Stringent government specifications for safety and reliability have prevented some environmentally-friendly materials from being implemented within vehicle applications.

Embodiments of the interior panels, such as a vehicle dashboard may be made from recyclable, recycled, sustainable, biodegradable, compostable and/or otherwise environmentally friendly materials. In one embodiment, these panels have similar or the same strength, durability and reliability of interior panels made from less environmentally friendly plastics or metals. It will be understood that the materials herein may be implemented in vehicle components other than dashboards, such as side door panels, rear window panels or other vehicle components. Increasing the use of environmentally-friendly materials within the components of a vehicle may decrease the environmental impact of the vehicle, for example, by reducing landfill waste and the vehicle's carbon footprint. Using environmentally friendly materials for components in a vehicle can be beneficial, particularly, for example, within electric vehicles.

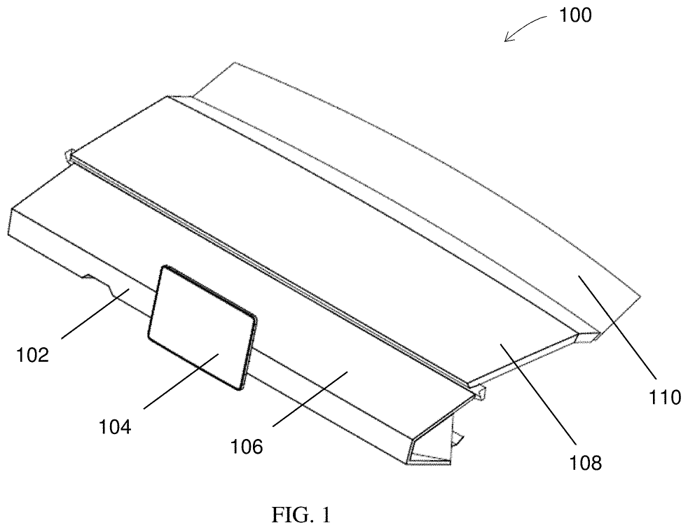

FIG. 1 illustrates an example of a dashboard 100 comprising an environmentally friendly material. The dashboard includes a front edge 102, which houses a display screen 104 mounted to the front edge 102. The front edge 102 is mated to a front horizontal surface 106, which itself connects to a middle horizontal surface 108, and finally connects to a rear horizontal surface 110. Each surface may be made from one or more recycled material. In one embodiment, all of the surfaces of the dashboard are made from a recycled material. In another embodiment, one or more of the front edge 102, front horizontal surface 106, middle horizontal surface 108, or rear horizontal surface 110 are made from recycled material.

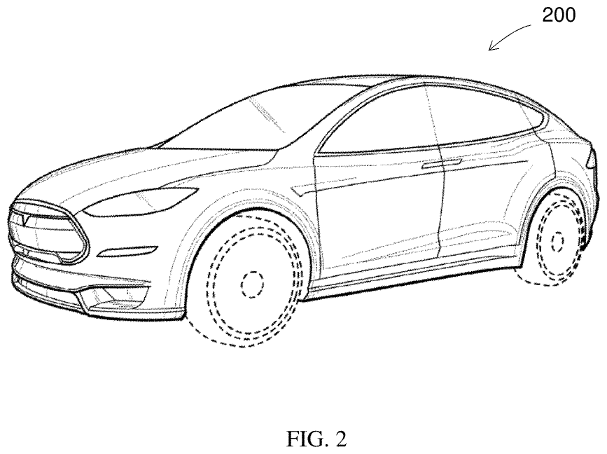

FIG. 2 is a perspective view of a vehicle (e.g. a car) 200 that may include an interior panel made from an environmentally friendly material, such as dashboard 100 of FIG. 1. In some embodiments, the vehicle further comprises an electric motor and battery for powering the vehicle.

The interior panel (e.g. dashboard) can include a sustainable, recyclable, recycled, biodegradable, compostable and otherwise environmentally friendly material. A “recyclable material” is a material wherein at least a portion of the material is capable of being reused and/or recycled. A “recycled material” is a material wherein at least a portion of the material was made from a recyclable material that has been reused and/or recycled. In some embodiments, the material of the interior panel (e.g. recycled material) comprises a base material (e.g. recycled base material). In some embodiments, the base material can include a sustainable, recyclable, recycled, biodegradable, compostable and otherwise environmentally friendly material. In some embodiments, the material of the interior panel (e.g. recycled material) comprises a resin (e.g. bio-based resin). In some embodiments, the resin can include a bio-based, sustainable, recyclable, recycled, biodegradable, compostable and otherwise environmentally friendly resin. In some embodiments, the resin includes a non-recycled (i.e. prime or virgin) and/or non-recyclable resin. In some embodiments, the interior panel comprises a material, wherein the material comprises a base material and a resin. In some embodiments, the interior panel comprises a recycled material, wherein the recycled material comprises a recycled base material and a resin. In some embodiments, the interior panel comprises a recycled material, wherein the recycled material comprises a recycled base material and a bio-based resin. In some embodiments, the recycled material is recyclable, biodegradable, compostable and otherwise environmentally friendly material. It is to be understood that the interior panel can be made of a material comprising various combinations of the materials described herein, with or without other materials. In some embodiments, the interior panel can include one or more recycled or recyclable materials.

In some embodiments, the recycled material is a top most layer of the interior panel. In some embodiments, the interior panel further comprises a substrate material disposed under the recycled material. In some embodiments, the substrate material provides structural support to the interior panel and/or the recycled material. In some embodiments, the substrate material includes a plastic material. In some embodiments, the recycled material is self-supporting, and does not require a support structure in order to hold its form. In some embodiments, the interior panel comprises a film disposed over the recycled material. In some embodiments, the interior panel does not comprise a film disposed over the recycled material. In some embodiments, the interior panel further comprises a tear seam. In some embodiments, the tear seam is configured to tear due to the force caused by a deployed airbag. In some embodiments, the recycled material is a treated recycled material. In some embodiments, the treated recycled is are treated for increased strength. In some embodiments, the treated recycled material is chemically treated for increased strength and/or durability.

In some embodiments, the recycled material is resistant to temperature damage from temperatures of, of about, of at most, of at most about, of at least, or of at least about −70° C., −60° C., −50° C., −40° C., −30° C., −20° C., −10° C., 0° C., 10° C., 20° C., 30° C., 40° C., 50° C., 60° C., 70° C., 80° C., 90° C., 100° C., 115° C., 120° C., 130° C. or 150° C., or any range of values therebetween. In some embodiments, the recycled material is resistant to humidity damage from atmospheric humidities of, of about, of at least, or of at least about, 0%, 1%, 5%, 10%, 20%, 30%, 40%, 50%, 60%, 65%, 70%, 75%, 80%, 85%, 90%, 92%, 95%, 96%, 97%, 98%, 99%, or 99.5%, or any range of values therebetween. In some embodiments, humidity damage resistance testing is performed according to FMVSS No. 108. In some embodiments, the recycled material has an ultraviolet (UV) damage resistance of, of about, of at least, or of at least about, 300 kJ/m², 400 kJ/m², 500 kJ/m², 600 kJ/m², 700 kJ/m², 800 kJ/m², 1000 kJ/m², 1100 kJ/m², 1150 kJ/m², 1180 kJ/m², 1190 kJ/m², 1200 kJ/m², 1205 kJ/m², 1210 kJ/m², 1250 kJ/m², 1300 kJ/m², 1400 kJ/m², 1600 kJ/m², 1800 kJ/m², 2000 kJ/m², 2500 kJ/m², 3000 kJ/m² or 5000 kJ/m², or any range of values therebetween. In some embodiments, UV damage resistance testing is performed according to FMVSS No. 205. In some embodiments, the recycled material has a flammability resistance of, of about, of at most, or of at most about, 30 mm/min, 50 mm/min, 60 mm/min, 70 mm/min, 75 mm/min, 80 mm/min, 85 mm/min, 90 mm/min, 95 mm/min, 98 mm/min, 100 mm/min, 102 mm/min, 105 mm/min, 110 mm/min, 120 mm/min, 150 mm/min, 200 mm/min, 300 mm/min, 500 mm/min or 1000 mm/min, or any range of values therebetween. In some embodiments, flammability testing is performed according to FMVSS No. 302.

The base material may be a recycled base material. In some embodiments, the recycled base material is selected from the group consisting of a bio-based (or renewable) material, a petrochemical-based (or non-renewable) material, and combinations thereof. In some embodiments, the recycled base material (e.g. bio-based material and/or petrochemical-based material) is selected from the group consisting of paper, cardboard, fiberboard, wood, pulp, bamboo, hemp, cork, desert sand, bioplastics, mycelium, a fiber alloy, cellulose nanofibers, biodegradable polymers (BDPs) (e.g. biodegradable plastics), and combinations thereof. In some embodiments, the recycled material comprises the recycled base material in an amount of, of about, of at least, or of at least about, 30 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 92 wt. %, 95 wt. %, 98 wt. % or 99 wt. %, or any range of values therebetween.

In some embodiments, the fiberboard is a biodegradable fiberboard. In some embodiments the fiberboard (e.g. biodegradable fiberboard) is a medium density fiberboard (MDF). In some embodiments, MDF is used in combination with a bio-based and/or biodegradable resin (e.g. potato starch) to form the recycled material. In some embodiments, the cellulose nanofibers are wood nanofibers.

In some embodiments, the a BDP is selected from the group consisting of natural rubbers, polyesters, aliphatic polyesters, aromatic copolyesters, poly(vinyl alcohol), polyhydroxyalkanoate based BDP, a poly-3-hydroxybutyrate based BDP, a polyglycolic acid based BDP, a polybutylene succinate based BDP, a polycaprolactone (PCL) based BDP, and a polybutylene succinate terephthalate based BDP, polysaccharides (e.g. starch, cellulose, lignin and chitin), proteins (e.g. gelatine, casein, wheat gluten, silk and wool), lipids (e.g. plant oils and animal fats), natural rubbers, polyesters produced by micro-organisms and/or plants (e.g. polyhydroxyalkanoates and poly-3-hydroxybutyrate), polymers synthesized from bio-derived monomers (e.g. polylactic acid (PLA), aliphatic polyesters (e.g. polyglycolic acid, polybutylene succinate and polycaprolactone (PCL)), aromatic copolyesters (e.g. polybutylene succinate terephthalate), poly(vinyl alcohol), and combinations thereof. In some embodiments, the a BDP is selected from the group consisting of natural rubbers, polyesters, aliphatic polyesters, aromatic copolyesters, poly(vinyl alcohol), and combinations thereof. In some embodiments, the BDP is selected from a polyhydroxyalkanoate based BDP, a poly-3-hydroxybutyrate based BDP, a polyglycolic acid based BDP, a polybutylene succinate based BDP, a polycaprolactone (PCL) based BDP, and a polybutylene succinate terephthalate based BDP, and combinations thereof. In some embodiments, a BDP (e.g. biodegradable plastics) comprises a polymer selected from a bio-based polymer (i.e. biogenic and/or biomass derived polymer from plants, animals and/or micro-organisms), a petrochemical-based polymer, and combinations thereof. In some embodiments, the BDPs or polymers are bio-based. In some embodiments, the bio-based BDPs or polymers are selected from polysaccharides (e.g. starch, cellulose, lignin and chitin), proteins (e.g. gelatine, casein, wheat gluten, silk and wool), lipids (e.g. plant oils and animal fats), natural rubbers, polyesters produced by micro-organisms and/or plants (e.g. polyhydroxyalkanoates and poly-3-hydroxybutyrate), polymers synthesized from bio-derived monomers (e.g. polylactic acid (PLA), and combinations thereof. In some embodiments, the BDPs or polymers are petrochemical-based. In some embodiments, petrochemical-based BDPs are selected from aliphatic polyesters (e.g. polyglycolic acid, polybutylene succinate and polycaprolactone (PCL)), aromatic copolyesters (e.g. polybutylene succinate terephthalate), poly(vinyl alcohol), and combinations thereof.

In some embodiments, the base material are treated base materials. In some embodiments, the treated base materials are treated for increased strength. In some embodiments, the treated base materials are chemically treated for increased strength and/or durability. In some embodiments, the base material are processed base materials. In some embodiments, the processed base materials are processed for increased strength and/or durability. In some embodiments, the base material is exposed to heat and/or pressure in order to form the processed base material. In some embodiments, the processed base material are processed cellulose fibers.

Resins used in the interior panel may strengthen the base material. In some embodiments, the resin is a recyclable resin. In some embodiments, the recyclable resin is biodegradable and/or biobased. In some embodiments, the resin includes a non-recycled (i.e. prime or virgin) and/or non-recyclable resin. In some embodiments, the resin is selected from one or more of an acrylic resin, a urethane resin, a biodegradable polymer (BPD)-based resin, biodegradable resin, and a bio-based resin. In some embodiments, the biodegradable resin is selected from one or more of a BPD-based resin and potato starch. In some embodiments, the bio-based resin comprises potato starch. In some embodiments, the bio-based resin is potato starch. In some embodiments, the material of the interior panel (e.g. recyclable material) comprises the resin in an amount of, of about, of at most, or of at most about, 2 wt. %, 5 wt. %, 10 wt. %, 15 wt. %, 20 wt. %, 25 wt. %, 30 wt. % or 40 wt. %, or any range of values therebetween.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount, depending on the desired function or desired result.

The headings contained in this document, if any, are for convenience only and do not necessarily affect the scope or meaning of the devices and methods disclosed herein.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A vehicle having an interior panel, wherein the interior panel comprises a recycled material, and wherein the recycled material comprises a recycled base material and a resin.

2. The vehicle of claim 1, wherein the recycled material is biodegradable.

3. The vehicle of claim 1, wherein the recycled material is a recyclable material.

4. The vehicle of claim 1, wherein the recycled base material is selected from the group consisting of a bio-based material, a petrochemical-based material, and combinations thereof.

5. The vehicle of claim 2, wherein the recycled base material is selected from the group consisting of paper, cardboard, fiberboard, wood, pulp, bamboo, hemp, cork, desert sand, bioplastics, mycelium, a fiber alloy, cellulose nanofibers, biodegradable polymers (BDPs), and combinations thereof.

6. The vehicle of claim 5, wherein the fiberboard is medium density fiberboard (MDF).

7. The vehicle of claim 5, wherein the cellulose nanofibers are wood nanofibers.

8. The vehicle of claim 5, wherein the BDPs are selected from the group consisting of natural rubbers, polyesters, aliphatic polyesters, aromatic copolyesters, poly(vinyl alcohol), and combinations thereof.

9. The vehicle of claim 8, wherein the BDPs are selected from the group consisting of a polyhydroxyalkanoate based BDP, a poly-3-hydroxybutyrate based BDP, a polyglycolic acid based BDP, a polybutylene succinate based BDP, a polycaprolactone (PCL) based BDP, and a polybutylene succinate terephthalate based BDP, and combinations thereof.

10. The vehicle of claim 1, wherein the recycled material comprises the recycled base material in an amount of at least about 50 wt. %.

11. The vehicle of claim 1, wherein the resin is selected from the group consisting of: an acrylic resin, a urethane resin, a BPD-based resin, biodegradable resin, and a bio-based resin.

12. The vehicle of claim 1, wherein the resin is potato starch.

13. The vehicle of claim 1, wherein the recycled material comprises the resin in an amount from about 10 wt. % to about 20 wt. %.

14. The vehicle of claim 1, wherein the recycled material is resistant to temperature damage from temperatures of about −40° C. to about 115° C.

15. The vehicle of claim 1, wherein the recycled material is resistant to humidity damage from atmospheric humidities of at least about 95%.

16. The vehicle of claim 1, wherein the recycled material has an ultraviolet (UV) damage resistance of at least about 1200 kJ/m².

17. The vehicle of claim 1, wherein the recycled material has a flammability resistance of at most about 100 mm/min.

18. The vehicle of claim 1, wherein the recycled material is a treated recycled material.

19. The vehicle of claim 1, wherein the recycled material is a top most layer of the interior panel.

20. The vehicle of claim 1, wherein the interior panel further comprises a substrate material disposed under the recycled material.

21. The vehicle of claim 1, wherein the interior panel comprises a film disposed over the recycled material.

22. The vehicle of claim 1, wherein the interior panel does not comprise a film disposed over the recycled material.

23. The vehicle of claim 1, wherein the interior panel further comprises a tear seam, wherein the tear seam is configured to tear due to the force caused by a deployed airbag.

24. The vehicle of claim 1, wherein the interior panel is a dashboard.

25. The vehicle of claim 1, further comprising an electric motor.
